(19) United States
(12) Patent Application Publication
(10) Pub. No.: US 2014/0302764 A1
(43) Pub. Date: Oct. 9, 2014

(54) SOLAR POWERED HEAT-DISSIPATING DEVICE USED ON CAR WINDOW

(71) Applicants: Yung-Yu Wu, Pingtung County (TW); Chih-Hung Chiu, Irvine, CA (US); Chien-Chia Lai, New Taipei City (TW)

(72) Inventors: Yung-Yu Wu, Pingtung County (TW); Chih-Hung Chiu, Irvine, CA (US); Chien-Chia Lai, New Taipei City (TW)

(21) Appl. No.: 14/352,035

(22) PCT Filed: Jun. 21, 2012
(86) PCT No.: PCT/US2012/043417

§ 371 Date: Apr. 15, 2014

(51) Int. Cl. B60H 1/26; F24F 7/013

(52) U.S. Cl. CPC B60H 1/265; F24F 7/013
USPC 454/133; 454/207

(57) ABSTRACT

A solar powered heat-dissipating device used on a car window is configured to straddle on a side window glass of a car and includes a straddling base, two wind-generating units and a solar cell panel. The straddling base straddles on an upper edge of the side window glass. The interior of the straddling base has two separated air channels for allowing air to flow inward and outward of the car respectively. The two wind-generating units are provided in the two air channels respectively. The flowing directions of the airflows respectively generated by the two wind-generating units are opposite to each other. The solar cell panel is disposed on the straddling base to protrude out of the car. The solar cell panel is pivotally connected to the straddling base and rotatable relative to the straddling base for adjusting its inclination angle.

### BACKGROUND OF THE INVENTION

1. Field of the Invention

The present invention relates to a heat-dissipating device, and in particular to a solar powered heat-dissipating device used on a car window.

2. Description of Prior Art

Cars have become an important transportation in our daily life. However, cars are usually parked outdoors and exposed to the sunlight until a driver and passengers get into the car next time. Since the car is exposed to the sunshine for a period of time, the temperature inside the car rises to such an extent that it is unsuitable for the driver and the passengers to sit in. Thus, automobile heat-dissipating devices are proposed, whereby ventilation can be generated between the inside and the outside of the car when the car is parked outside.

Although the conventional automobile heat-dissipating device is provided with a solar cell panel for generating a cooling airflow by using solar energy, the inclination angle of the solar cell panel cannot be adjusted. As a result, the thus-generated solar power is restricted by the illuminating angle of the sunlight on the solar cell panel. Further, the conventional automobile heat-dissipating device is merely provided with a fan to expel the air inside the car to the outside, but it is unable to provide a circulative airflow to enhance the air convection in the car. Further, the conventional automobile heat-dissipating device is inconvenient in use due to its insufficient functions.

In view of the above, the present Inventor proposes a novel and reasonable structure to solve the problems in prior art based on his expert knowledge and deliberate researches.

### SUMMARY OF THE INVENTION

The present invention is to provide a solar powered heat-dissipating device used on a car window, in which a straddling base is provided for combining two fans and a solar cell panel.

The combination can be mounted onto a car window and a user can freely adjust the angle of the solar cell panel to continuously provide airflow for convection.

The present invention is further to provide a solar powered heat-dissipating device used on a car window, which can be added with other functions based on practical demands or various designs via the straddling base.

The present invention provides a solar powered heat-dissipating device used on a car window, which straddles on a side window glass of a car and includes a straddling base, two wind-generating units and a solar cell panel. The straddling base is mounted on an upper edge of the side window glass. The interior of the straddling base has two separated air channels for allowing air to flow inward and outward of the car respectively. The two wind-generating units are provided in the two air channels respectively. The flowing directions of the airflows generated by the two wind-generating units are opposite to each other. The solar cell panel is disposed on the straddling base to face the outside of the car and pivotally provided on the straddling base, so that a user can rotate the solar cell panel to adjust its inclination angle.

### BRIEF DESCRIPTION OF DRAWING

FIG. 1 is an exploded perspective view of the present invention;

FIG. 2 is an exploded perspective view of the present invention taken from another viewing angle;

FIG. 3 is an assembled perspective view of the present invention;

FIG. 4 is an assembled perspective view of the present invention taken from another viewing angle;

FIG. 5 is a schematic view showing that the present invention is mounted on the car window;

FIG. 6 is a schematic view showing an operating state of the present invention; and

FIG. 7 is a schematic view showing the adjustment of inclination angles of the solar cell panel of the present invention.

### DETAILED DESCRIPTION OF THE INVENTION

In order to better understand the characteristics and technical contents of the present invention, a detailed description relating thereto will be made with reference to the accompanying drawings. However, the drawings are illustrative only, but are not used to limit the scope of the present invention.

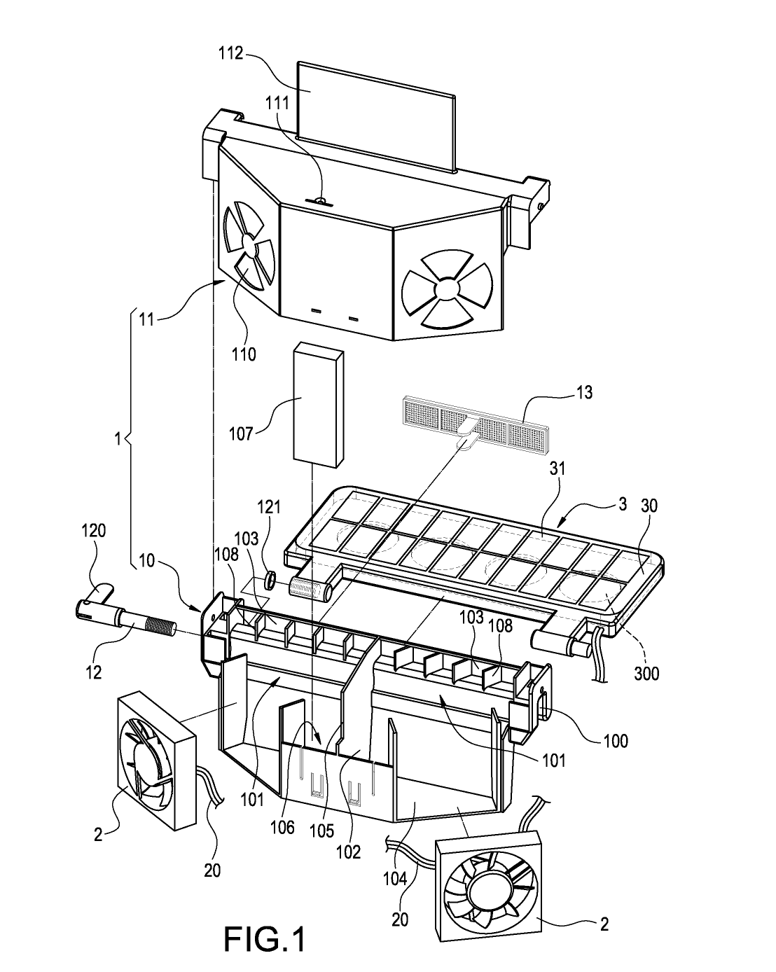

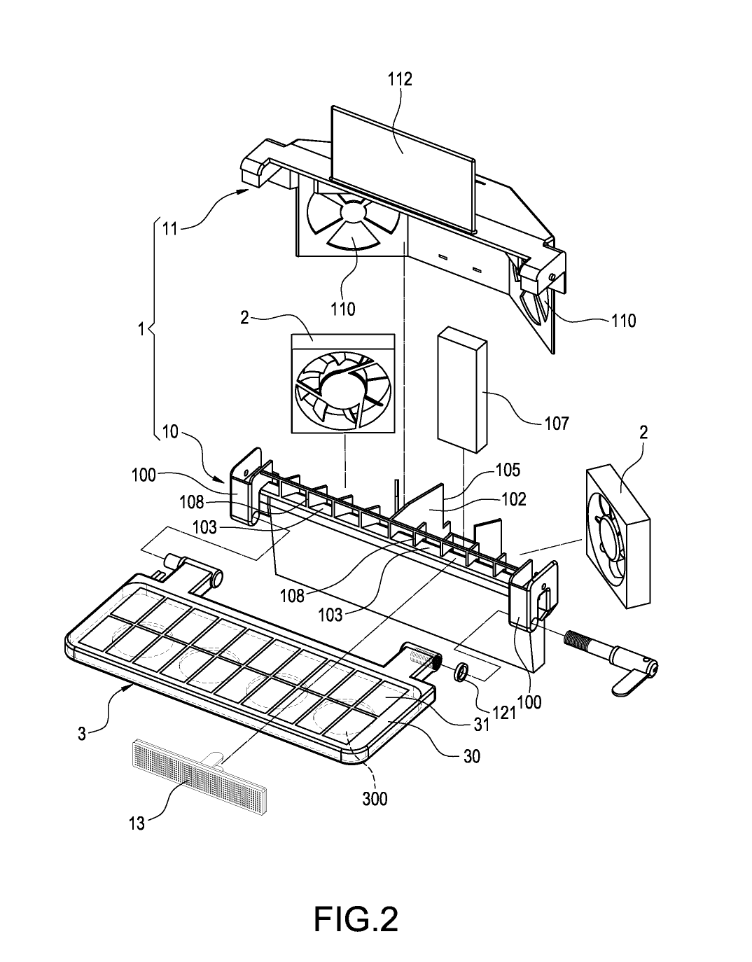

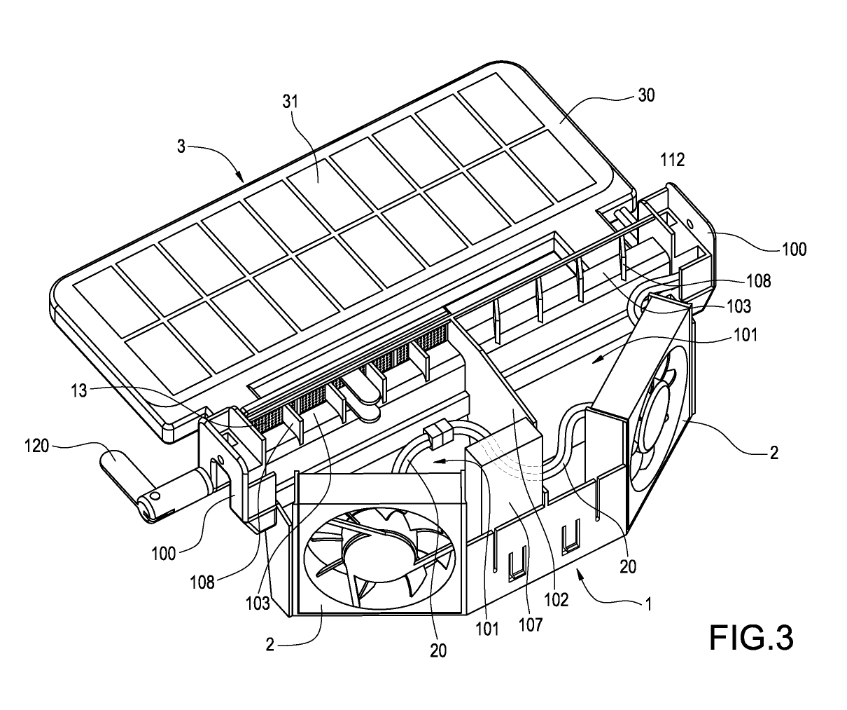

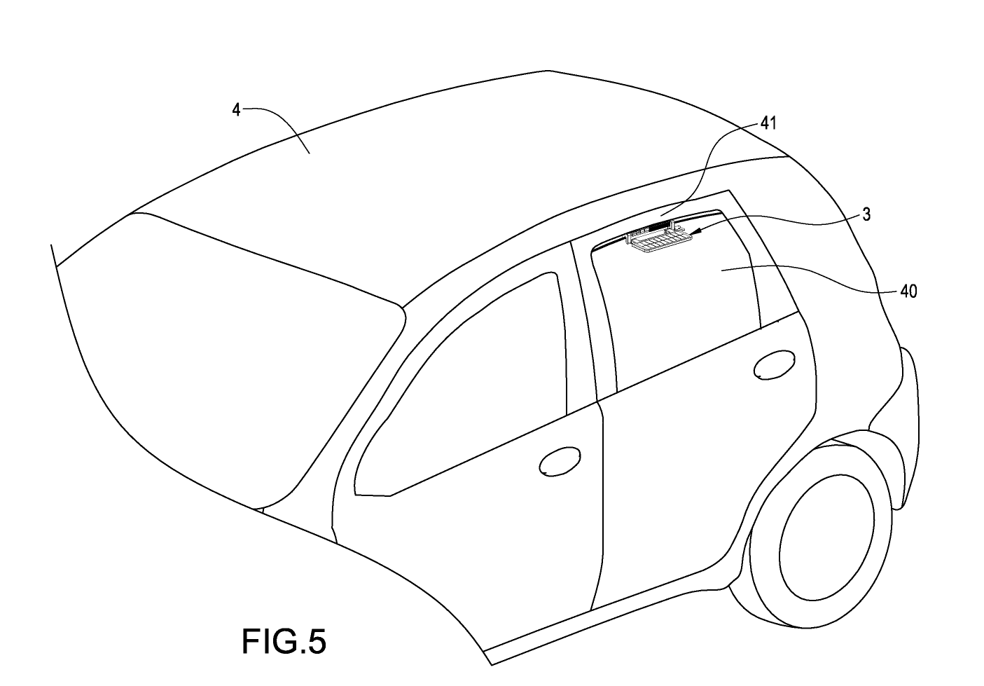

Please refer to FIGS. 1 to 3. FIG. 1 is an exploded perspective view of the present invention. FIG. 2 is an exploded perspective view of the present invention taken from another viewing angle. FIG. 3 is an assembled perspective view of the present invention. The present invention provides a solar powered heat-dissipating device used on a car window, which straddles on a side window glass 40 of a car 4 as shown in FIG. 5. When the car is parked outdoors or exposed to strong sunlight, the present invention can expel the original air inside the car 4 to the outside and introduce external fresh air into the car 4. In this way, the temperature inside the car 4 can be prevented from rising so high as to be unsuitable for the driver and passengers to sit in. The solar powered heat-dissipating device includes a straddling base 1, two wind-generating units 2, and a solar cell panel 3.

The straddling base 1 is a hollow casing and has at least one inverted U-shaped hook 100 on its one side. The hook 100 is used to straddle on an upper edge of the side window glass 40. The interior of the straddling base 1 has two separated air channels 101. When the straddling base 1 straddles on the side window glass 40, the two air channels 101 allow air to flow inward and outward of the car 4 respectively. In the present embodiment, the straddling base 1 comprises a lower casing 10 and an upper casing 11. The lower casing 10 is provided with an upright separating panel 102 to separate the two air channels 101. The two air channels 101 extend from one side to the other side of the straddling base 1. One side of the straddling base 1 near the hook 100 is formed with a port 103. Another side of the straddling base 1 is formed with mounting regions 104 for allowing the two wind-generating units 2 to be disposed therein respectively. The upper casing 11 is provided with a plurality of wind holes 110 corresponding to the mounting regions 104 and thus the wind-generating units 2. Further, a wiring hole 105 is provided on the separating plate 102 between the two mounting regions 104, so that electric wires 20 of the two wind-generating units 2 can be disposed through the wiring hole 105 respectively. In this way, the two wind-generating units 2 can be electrically connected to the solar cell panel 3.

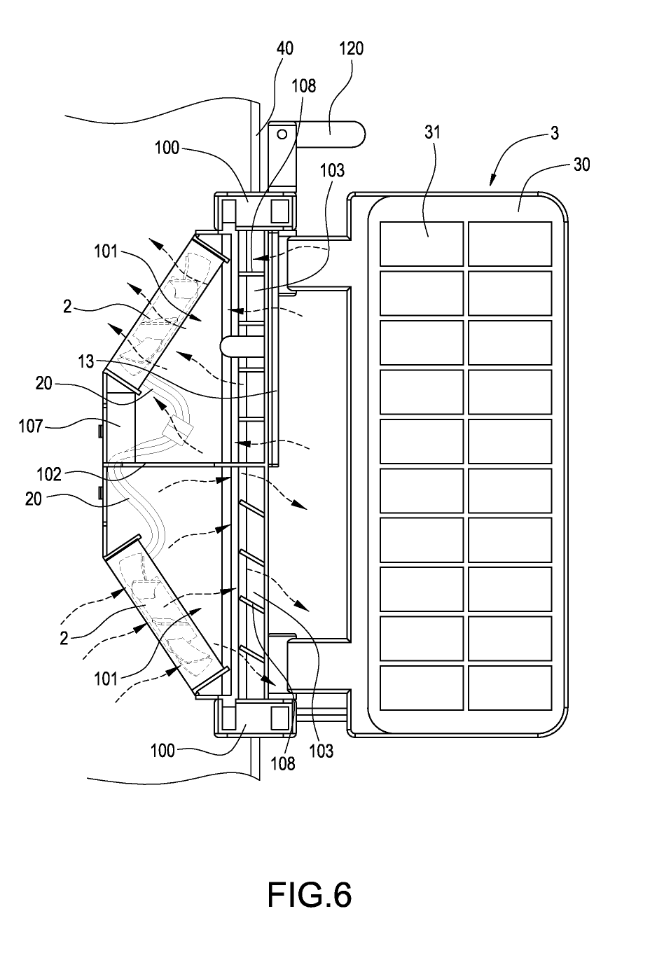

The two wind-generating units 2 are disposed in the two air channels 101 of the straddling base 1 respectively (i.e., in the mounting regions 104 of the air channels 101 respectively). The two wind-generating units 2 may be fans. The flowing directions of airflows generated by the two wind-generating units 2 are opposite to each other. As shown in FIG. 6, one of the wind-generating unit 2 provides an intake airflow, and the other wind-generating unit 2 provides an exhaust airflow. At this time, the two wind-generating units 2 (or the mounting regions 104 of the two air channels 101) may be arranged to incline outwardly relative to each other, thereby preventing against short air circulation.

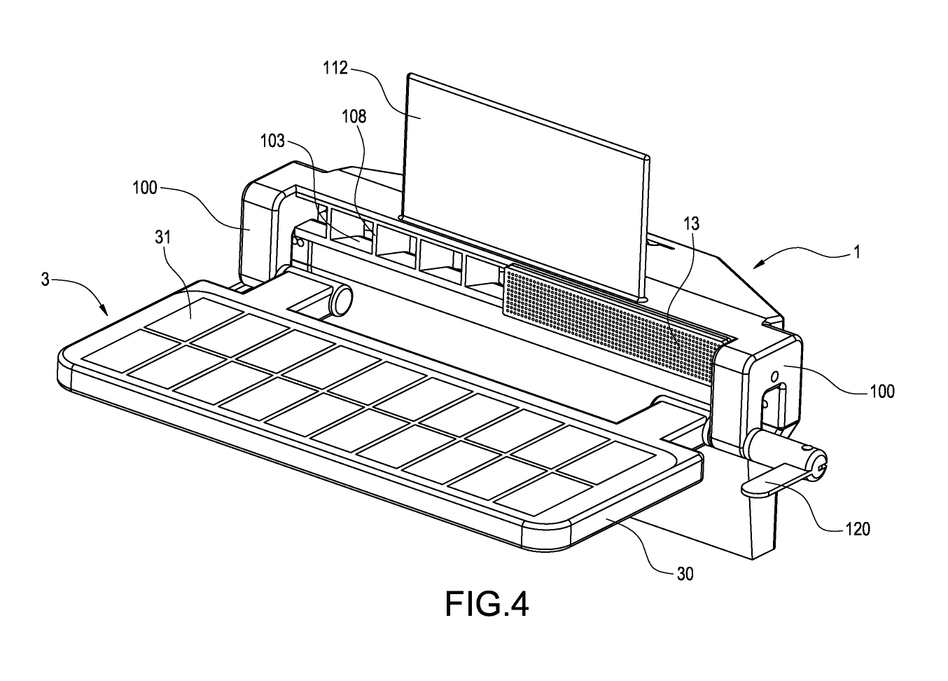

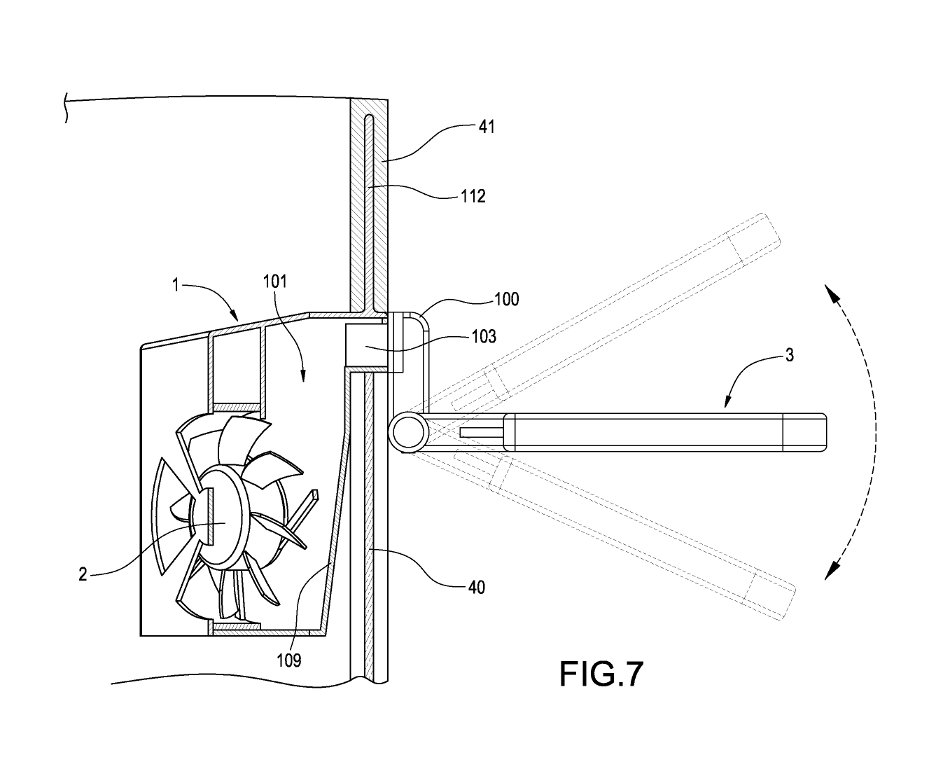

Please refer to FIG. 4. The solar cell panel 3 is provided on the straddling base 1. When the straddling base 1 straddles on an upper edge of the side window glass 40, the solar cell panel 3 is pivotally connected to the straddling base 1 via a pivotal shaft 12 in such a manner that the solar cell panel 3 is located outside the car 4. The user can freely adjust the inclination angle of the solar cell panel 3 as shown in FIG. 7. In the present embodiment, the solar cell panel 3 comprises a panel body 30, and a plurality of photoelectrical conversion chips 31 provided on the panel body 30. Each photoelectrical conversion chip 31 is provided on the upper surface of the panel body 30. The panel body 30 is provided with a plurality of heat-dissipating holes 300 penetrating all the way through itself. The heat generated by the photoelectrical conversion chips 31 is dissipated to the outside via the heat-dissipating holes 300. In a preferred embodiment, the solar cell panel 3 may be located below the port 103 of the straddling base 1, so that the airflow passing through the port 103 can enhance the heat-dissipating efficiency to the solar cell panel 3.

Please also refer to FIG. 3. In the straddling base 1, an accommodating region 106 is formed near the mounting region 104 of one air channel 101 (the intake channel is preferable). The accommodating region 106 is provided to be adjacent to the separating plate 102. The accommodating region 106 is disposed therein with a liquid-absorbing body 107 (e.g. sponge) for absorbing aromatic liquid such as essential oils. A droplet hole 111 is provided on the upper case 11 of the straddling base 1 above the accommodating region 106, so that droplets of the aromatic liquid such as essential oils can drop into the liquid-absorbing body 107 in the accommodating region 106. When the wind-generating unit 2 provides intake airflow, the intake airflow brings the aromatic vapors into the car 4. At this time, the liquid-absorbing liquid 107 can be arranged to abut against one side of the wiring hole 105 of the separating plate 102, thereby reducing the amount of airflow in the two air channels 101 communicating to each other via the wiring hole 105.

By the above arrangement, the solar powered heat-dissipating device used on a car window according to the present invention can be obtained.

As shown in FIGS. 5 and 6, the hook 100 of the straddling base 1 straddles on the upper edge of the side window glass 40 of the car 4. Further, the straddling base 1 may have an anchoring plate 112 erected on the upper casing 11. The anchoring plate 112 is fitted into a glass-receiving frame of the car 4, thereby increasing the stability of the inventive solar powered heat-dissipating device on the side window glass 40. When the two wind-generating units 2 are in operation, since the flowing directions of the airflows generated by the two wind-generating units 2 are opposite to each other, two circulative airflows including intake airflow and exhaust airflow can be generated. In this way, the high-temperature air inside the car 4 can be expelled to the outside, while the cool fresh air outside the car 4 can be introduced in the car 4. Alternatively, the port 103 of the two air channel 101 may be provided with a plurality of air-guiding pieces 108. The air-guiding pieces 108 of one or both air channels 101 are arranged to incline outwardly, thereby preventing short air circulation. The port 103 of one of the air channels 101 (the intake channel is preferable) is provided with a filtering screen 13 for filtering out the impurities contained in the air entering the car 4.

Please also refer to FIG. 7. The inner surfaces of the two air channels 101 facing the two wind-generating units 2 may be further formed with an inclined guiding surface 109 respectively for guiding the airflow more smoothly. Further, an outer end of the pivotal shaft 12 is provided with an operating portion 120. The user can operate the operating portion 120 to rotate the pivotal shaft 12, thereby adjusting the inclination angle of the solar cell panel 3. Between the pivotal shaft 12 and the solar cell panel 3, a gasket 121 may be provided to increase the frictional force there between. By this arrangement, the solar cell panel 3 can be adjusted to a desired angular position more easily and correctly without loosening.

According to the above, the present invention really solves the problems in prior art and achieves the desired effects. Further, the present invention indeed demonstrates novelty and inventive steps, which conforms to the requirements for an invention patient.

Although the present invention has been described with reference to the foregoing preferred embodiment, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

1. A solar powered heat-dissipating device used on a car window, configured to straddle on a side window glass of a car and including:
a straddling base straddling on an upper edge of the side window glass, the interior of the straddling base having two separated air channels for allowing air to flow inward and outward of the car respectively;
two wind-generating units provided in the two air channels respectively, flowing directions of the airflows respectively generated by the two wind-generating units being opposite to each other; and
a solar cell panel disposed on the straddling plate to protrude out of the car, the solar cell panel being pivotally connected to the straddling base and rotatable relative to the straddling base for adjusting its inclination angle.

2. The solar heat-dissipating device used on a car window according to claim 1, wherein the straddling base has an anchoring plate erected thereon, and the anchoring plate is fitted into a glass-receiving frame of the car.

3. The solar heat-dissipating device used on a car window according to claim 1, wherein the two air channels extend from one side to the other side of the straddling base, one side of the straddling base is formed with a port, and the other side of the straddling base is formed with mounting regions for allowing the two wind-generating units to be mounted therein respectively.

4. The solar heat-dissipating device used on a car window according to claim 3, wherein the solar cell panel is located below the port.

5. The solar heat-dissipating device used on a car window according to claim 3, wherein a portion of the port in one of the air channels is provided with a filtering screen.

6. The solar heat-dissipating device used on a car window according to claim 3, wherein inner surfaces of the two air channels facing the two wind-generating units are formed with an inclined guiding surface respectively.

7. The solar heat-dissipating device used on a car window according to claim 3, wherein the port of the two air channels is provided with a plurality of air-guiding pieces.

8. The solar heat-dissipating device used on a car window according to claim 7, wherein the air-guiding pieces are arranged to incline outwardly.

9. The solar heat-dissipating device used on a car window according to claim 3, wherein the straddling base comprises an upper casing and a lower casing, the lower casing is provided with an erected separating plate for separating the two air channels, the upper casing is provided with a plurality of wind holes corresponding to the two mounting regions and the two wind-generating units.

10. The solar heat-dissipating device used on a car window according to claim 9, wherein an accommodating region is provided near the mounting region of one of the air channels, the accommodating region is disposed therein with a liquid-absorbing body for absorbing aromatic liquid.

11. The solar heat-dissipating device used on a car window according to claim 10, wherein the upper casing is provided with a droplet hole above the accommodating region.

12. The solar heat-dissipating device used on a car window according to claim 10, wherein the separating plate separating the two mounting regions is provided with a wiring hole for allowing electric wires of the two wind-generating units to pass through.

13. The solar heat-dissipating device used on a car window according to claim 12, wherein the liquid-absorbing body is arranged to abut against the wiring hole of the separating plate.

14. The solar heat-dissipating device used on a car window according to claim 1, wherein the two wind-generating units are arranged to incline outwardly relative to each other.

15. The solar heat-dissipating device used on a car window according to claim 1, wherein the solar cell panel is pivotally connected to the straddling base via a pivotal shaft.

16. The solar heat-dissipating device used on a car window according to claim 15, wherein the solar cell panel comprises a panel body and a plurality of photoelectric conversion chips provided on the panel body, each photoelectric conversion chip is provided on an upper surface of the panel body, the panel body is provided with heat-dissipating holes penetrating all the way through itself.

17. The solar heat-dissipating device used on a car window according to claim 15, wherein an outer end of the pivotal shaft is provided with an operating portion.

18. The solar heat-dissipating device used on a car window according to claim 15, wherein a gasket is provided between the pivotal shaft and the solar cell panel.
